(19) United States
(12) Patent Application Publication
(10) Pub. No.: US 2023/0307766 A1
(43) Pub. Date: Sep. 28, 2023

(54) TRACTION BATTERY PACK ASSEMBLY METHOD

(71) Applicant: Ford Global Technologies, LLC, Dearborn, MI (US)

(72) Inventor: Marc Dugas, Wixom, MI (US)

(21) Appl. No.: 17/942,656

(22) Filed: Sep. 12, 2022

Related U.S. Application Data
(60) Provisional application No. 63/322,766, filed on Mar. 23, 2022.

(51) Int. Cl. H01M 50/262; H01M 50/209; H01M 50/249

(52) U.S. Cl. CPC H01M 50/262; H01M 50/209; H01M 50/249; H01M 2220/20

(57) ABSTRACT

A battery pack assembly method includes inserting a plurality of cell stacks into an enclosure structure that compresses the plurality of cell stacks. The method further includes electrically connecting the plurality of cells stacks together and bonding the plurality of cell stacks after electrically connecting the plurality of cells stacks.

### CROSS-REFERENCE TO RELATED APPLICATIONS

This application claims priority to U.S. Provisional Application No. 63/322,766, which was filed on 23 Mar. 2022 and is incorporated herein by reference.

### TECHNICAL FIELD

This disclosure relates generally to a method of assembling a traction battery pack and, more particularly, to how cell stacks are assembled into an enclosure of the battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a battery pack assembly method, including: inserting a plurality of cell stacks into an enclosure structure that compresses the plurality of cell stacks; electrically connecting the plurality of cells stacks together; and bonding the plurality of cell stacks after electrically connecting the plurality of cells stacks.

In some aspects, the techniques described herein relate to a method, wherein electrically connecting includes electrically connecting using busbars.

In some aspects, the techniques described herein relate to a method, further compressing the plurality of cells stacks during the inserting using a compressing machine.

In some aspects, the techniques described herein relate to a method, wherein the enclosure structure compresses each cell stack within the plurality of cell stacks along a respective cell stack axis.

In some aspects, the techniques described herein relate to a method, wherein the inserting moves the cell stack relative to the enclosure structure in a direction that is perpendicular to the cell stack axes.

In some aspects, the techniques described herein relate to a method, wherein the bonding is an adhesive bonding.

In some aspects, the techniques described herein relate to a method, wherein the bonding is an adhesive thermal interface material.

In some aspects, the techniques described herein relate to a method, further including conducting an electrical inspection after electrically connecting and prior to the bonding.

In some aspects, the techniques described herein relate to a method, further including replacing on or more cells in one or more of the cell stacks after the electrical inspection and prior to the bonding.

In some aspects, the techniques described herein relate to a method, further including electrically connecting the plurality of cell stacks together by securing at least one busbar to a plurality of terminals of the plurality of cell stacks.

In some aspects, the techniques described herein relate to a method, wherein the enclosure structure is an enclosure halo.

In some aspects, the techniques described herein relate to a method, further including securing an enclosure cover to the enclosure halo.

In some aspects, the techniques described herein relate to a method, wherein the enclosure cover is a first enclosure cover that is secured to the enclosure halo such that the first enclosure cover is adjacent first sides of the plurality of cell stacks, wherein the plurality of terminals are on second sides of the plurality of cell stacks, the first sides opposite the second sides.

In some aspects, the techniques described herein relate to a method, further including securing a second enclosure cover to the enclosure halo such that the second enclosure cover is adjacent the second sides of the plurality of cells stacks.

In some aspects, the techniques described herein relate to a method, wherein the enclosure halo, the first enclosure cover and the second enclosure cover provide an enclosure assembly that encloses the plurality of cell stacks.

In some aspects, the techniques described herein relate to a battery pack assembly method, including: electrically connecting a plurality of cell stacks while the plurality of cell stacks are compressed within an enclosure structure; and adhesively bonding the plurality of cell stacks after electrically connecting together the plurality of cells.

In some aspects, the techniques described herein relate to a method, wherein the enclosure structure is an enclosure halo.

In some aspects, the techniques described herein relate to a method, wherein a traction battery of an electrified vehicle includes the cells stacks.

In some aspects, the techniques described herein relate to a method, replacing at least one cell within the plurality of cell stacks after electrically connecting together the plurality of cell stacks and prior to adhesively bonding together the plurality of cell stacks.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a partially expanded view of a traction battery pack assembly from the electrified vehicle of FIG. 1 according to an exemplary aspect of the present disclosure.

FIG. 3 illustrates a group of cells being compressed by a compression fixture to provide a cell stack for the traction battery pack assembly of FIG. 2.

FIG. 4 illustrates the group of cells of FIG. 3 compressed by the compression fixture and providing the cell stack.

FIG. 5 illustrates the cell stack of FIG. 4 being aligned with other cell stacks to provide a cell matrix for the traction battery pack assembly of FIG. 2.

FIG. 6 illustrates the cell matrix of FIG. 5 being inserted into an enclosure halo.

FIG. 7 illustrates section view generally taken at line 7-7 in FIG. 6.

FIG. 8 illustrates a close-up view of an area of FIG. 7.

FIG. 9 illustrates the cell matrix of FIG. 6 after insertion into the enclosure halo.

FIG. 10A illustrates a section view at line 10-10 in FIG. 9 when a pusher is used to extract a cell from the cell matrix.

FIG. 10B illustrates the section view at line 10-10 in FIG. 9 after the pusher has extracted the cell from the cell matrix.

FIG. 11 illustrates the cell matrix and enclosure halo of FIG. 6 just before the securing of an enclosure floor.

FIG. 12 illustrates the cell matrix, enclosure halo, and enclosure floor of FIG. 11 after securing an enclosure cover.

### DETAILED DESCRIPTION

This disclosure details example traction battery pack assemblies having an enclosure that provides an interior area. Battery cells and electronic modules can be held within the interior area along with other components. The battery cells can be used to power an electric machine.

In particular, this disclosure details exemplary methods of assembling such traction battery packs. In these methods, the battery cells are electrically connected together prior to bonding the battery cells together. Battery cells can then be removed and replaced if needed, without needing to rupture bonds between the battery cells.

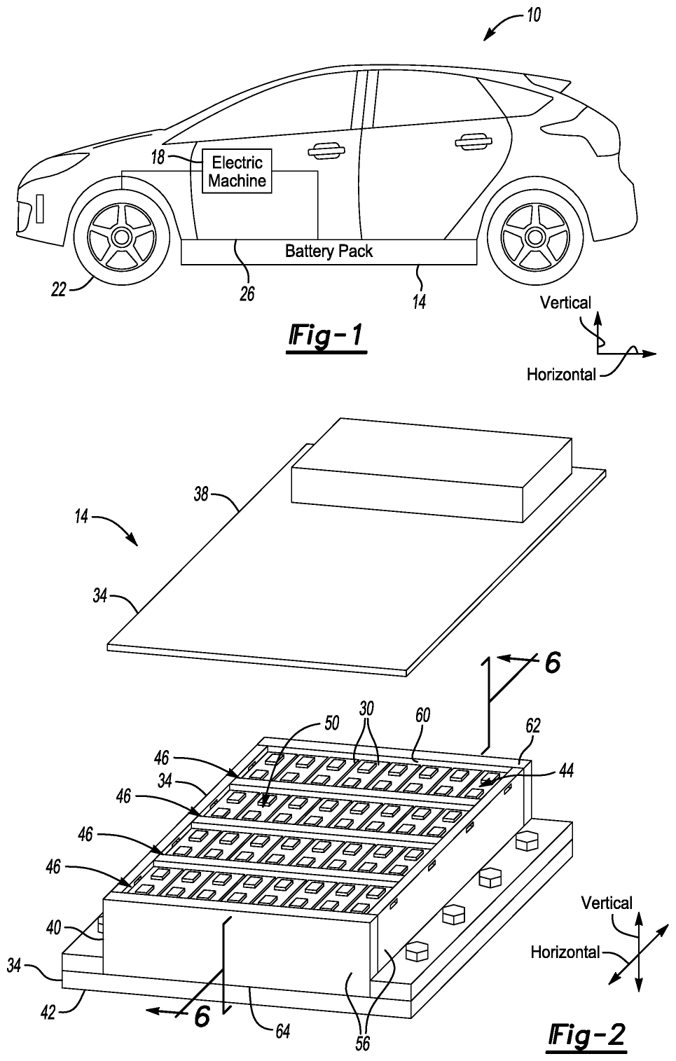

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the traction battery pack assembly 14 includes a plurality of battery cells 30 held within an enclosure assembly 34. In the exemplary embodiment, the enclosure assembly 34 comprises various enclosure structures. In particular, the example enclosure assembly 34 includes an enclosure cover 38, and enclosure halo 40, and an enclosure floor 42. The enclosure cover 38, enclosure halo 40, and enclosure floor 42 are secured together to provide an interior area 44 that houses the plurality of battery cells 30.

The plurality of battery cells (or simply, “cells”) 30 are for supplying electrical power to various components of the electrified vehicle 10. The battery cells 30 are stacked side-by-side relative to one another to construct one of a plurality of cell stacks 46, which are positioned side-by-side to provide a cell matrix 50. In this example, each cell stack 46 includes eight individual battery cells 30, and the cell matrix 50 includes four cell stacks 46. An even quantity of battery cells 30 and an even quantity of cell stacks 46 can help to support an efficient electrical bussing arrangement.

Although a specific number of battery cells 30 and cell stacks 46 are illustrated in the various embodiments of this disclosure, the traction battery pack assembly 14 could include any number of cells 30 and cell stacks 46. In other words, this disclosure is not limited to the specific configuration of cells 30 shown in FIG. 2.

In an embodiment, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure halo 40, in this example, includes a plurality of side walls 56 arranged relative to one another to provide a cell-receiving opening 60. The side walls 56 can be extruded, roll formed, cast, molded or other structures connected together by welding, fastening, or bonding, for example.

When the example traction battery pack assembly 14 is assembled, the enclosure cover 38 is secured to vertically upper side 62 of the enclosure halo 40. An interface between the enclosure cover 38 and the enclosure halo 40 extends circumferentially continuously about the interior area 44.

When the example traction battery pack assembly 14 is assembled, the enclosure floor 42 is secured to vertically lower side 64 of the enclosure halo 40. An interface between the enclosure floor 42 and the enclosure halo 40 extends circumferentially continuously about the interior area 44. Mechanical fasteners or welds, for example, can be used to secure the enclosure cover 38 and the enclosure floor 42 to the enclosure halo 40. Vertical, for purposes of this disclosure, is with reference to ground and a general orientation of the electrified vehicle 10 during operation.

When the traction battery pack assembly 14 is assembled, the cell matrix 50 is positioned within the cell-receiving opening 60. The example enclosure halo 40 includes one cell-receiving opening 60, but it should be understood that this disclosure also extends to enclosure assemblies providing more than one cell-receiving opening. The enclosure cover 38 can cover the cell matrix 50 within the cell-receiving opening 60 to substantially surround the cells 30 from all sides.

The enclosure halo 40 compresses and holds the cell matrix 50 after the cell matrix 50 is inserted into the cell-receiving opening 60 of the enclosure halo 40. The enclosure halo 40 is thus an enclosure structure that compresses the plurality of cell stacks 46. In this example, the side walls 56 of the enclosure halo 40 apply forces to the cell matrix 50 when the cell matrix 50 is positioned within the cell-receiving opening 60.

The traction battery pack assembly 14 can be considered a cell-to-pack battery assembly. Unlike conventional traction battery pack battery assemblies, a cell-to-pack battery assembly incorporates battery cells or other energy storage devices into the enclosure assembly 34 without the cells being arranged in arrays or modules. The enclosure assembly 34 applies compressive forces to the cells. The cell-to-pack battery assembly may therefore eliminate most, if not all, of the array support structures used in conventional battery arrays (e.g., array frames, spacers, rails, walls, endplates, bindings, etc.) that are used to group and hold the battery cells within the arrays/modules.

The cell matrix 50 comprises a plurality of separate cell stacks 46, which are simultaneously inserted into the cell-receiving opening of the enclosure halo 40. To insert the example cell matrix 50 into the cell-receiving opening 60, the cells stacks 46 of the cell matrix 50 are compressed, and, while compressed, moved into place in the cell-receiving opening 60. The fixturing relied on the compress the cell stacks 46 is removed as the cell matrix 50 is inserted. The cell stacks 46 can expand somewhat within the enclosure assembly 34, but are still compressed by the enclosure assembly 34.

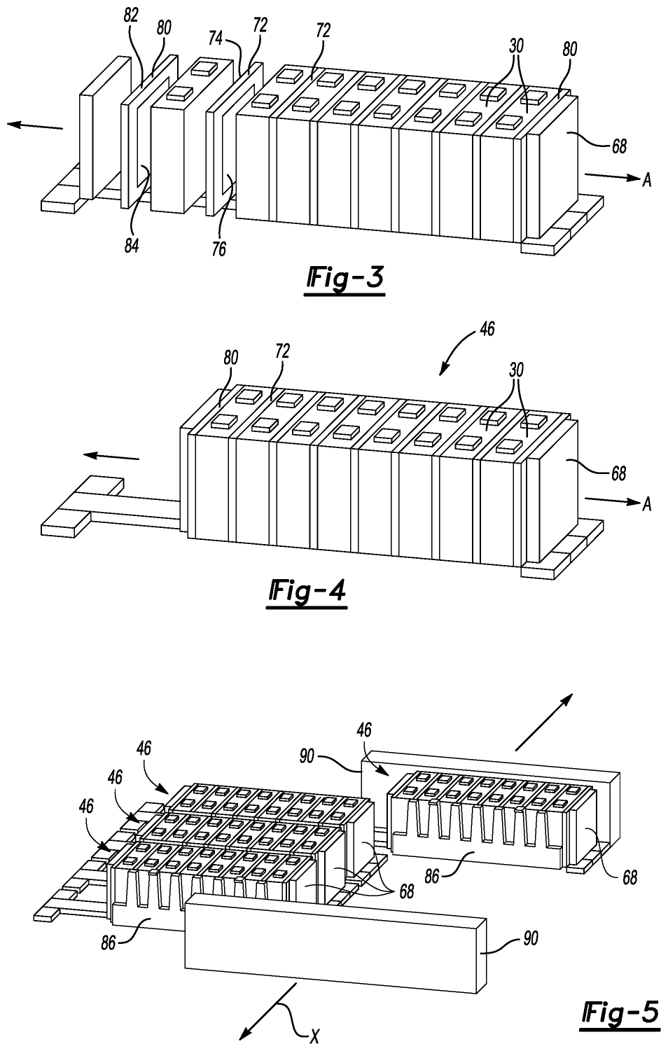

An exemplary method of assembling the traction battery pack assembly 14 will now be explained in connection with FIGS. 3-11.

First, groups of cells 30 are compressed along a cell stack axis A as shown in FIG. 3 to provide one of the cell stacks 46. A compression fixture 68 is used to compress the cells 30 along the cell stack axis A. The compressive force exerted on the cells 30 by the compression fixture 68 is 3 kilonewtons in some examples. An external unit can apply forces to the compression fixture 68 until reaching a position that applies the desired compressive force to the cell stack 46 along the cell stack axis A. The compression fixture 68 can then be locked in this position, and the external unit removed. The external unit could be a ball screw that presses against a die spring to move the compression fixture 68.

In this example, within the cells stacks 46, separator plates 72 are disposed between each of the cells 30 along the cell stack axis A. The separator plates 72 can include a frame portion 74 that holds a compressible material 76. The compressible material 76 can compress to permit some expansion of the cells 30. The compressible material 76 can be foam.

Within each of the cell stacks 46, slider plates 80 are disposed at opposing axial ends of the cells 30. The slider plates 80 include a frame portion 82 that holds a compressible material 84. The compressible material 84 can be foam. The compressible material 84 can compress to permit some expansion of the cells 30.

In the example method, this step is repeated four times to provide the four cell stacks 46 of the traction battery pack assembly 14. Each of the cell stacks 46 is compressed and held by a different compression fixture that mimics the compression fixture 68. Thus, four compression fixtures are used to provide the four cell stacks 46 of the example traction battery pack assembly 14.

Next, as shown in FIG. 5, the cell matrix 50 is established by positioning the cell stacks 46 side-by-side while compression fixtures 68 are holding the cell stacks 46. Spacers 86 are positioned between the each of the cell stacks 46. The spacers 86 can keep the cell stacks 46 from directly contacting one another and can provide a space to, as will be explained, introduce an adhesive between the cell stacks 46.

A cell matrix joiner assembly 90, in this examples, is moved by an actuator along a joiner axis X to press the cell stacks 46 together along the axis X and provide the cell matrix 50. When the traction battery pack assembly 14 is installed within the vehicle, the axis X corresponds to a longitudinal axis of the electrified vehicle 10.

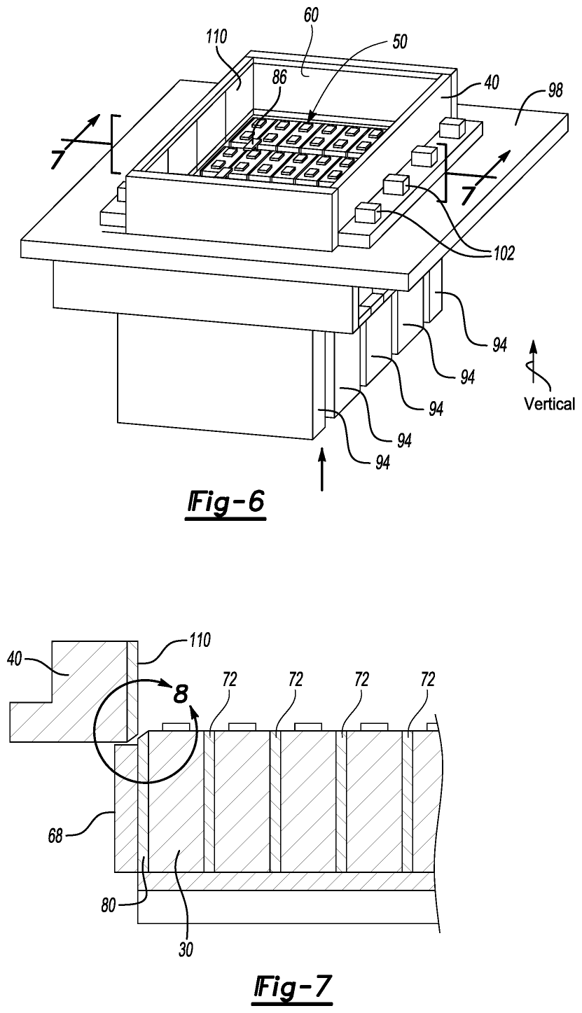

The cell matrix 50 is then moved relative to the enclosure halo 40 until the cell matrix 50 is vertically beneath the enclosure halo 40 and the cell-receiving opening 60 as shown in FIG. 6. The cell matrix joiner assembly 90 and the compression fixtures 68 hold together the cell matrix 50 until the cell matrix 50 is positioned vertically beneath the enclosure halo 40.

The assembly method then inserts the cell matrix 50 into the cell-receiving opening 60 of the enclosure halo 40. During the inserting, the enclosure halo 40 is secured to a halo pallet 98. Locator pins 102 can be used to locate the enclosure halo 40 relative to the halo pallet 98 during the inserting.

To insert the cell matrix 50, a plurality of plungers 94 are driven upwards by actuators to press the cell stacks 46 vertically upward out of the compression fixtures 68 and into the cell-receiving opening 60. In other examples, the cell stacks 46 can be inserted into the cell receiving opening 60 in other directions. The plungers 94 can move between apertures between the compression fixtures 68 so that the plungers 94 can contact the cell stacks 46 and move the cell stacks 46 into the cell-receiving opening 60 of the enclosure halo 40.

After the inserting, the enclosure halo 40 circumferentially surrounds the cell stack 46 of the cell matrix 50. The inserting positions the cell matrix 50 within the enclosure halo 40, which exerts a compressive force on the cell stacks 46. The enclosure halo 40 may permit some expansion of the cells 30 after being removed from the compression fixtures 68. A compressive force exerted on the cell stack 46 by the enclosure halo 40 after the inserting is thus less than a compressive force exerted on the cell stacks by the compression fixtures 68.

With reference to FIGS. 7 and 8 and continued reference to FIG. 6, to facilitate the inserting, the inner surfaces of the example enclosure halo 40 are lined with shim plates 110 having leading edges 114 that are chamfered. The slider plates 80 associated with the cell stacks 46 have a leading edge 118 that is chamfered. The slider plates 80 interface directly with the shim plates 110 during the inserting. Chamfers on the leading edges 114 and the leading edges 118 can help to guide the cell stacks 46 into the cell-receiving opening 60 during the inserting.

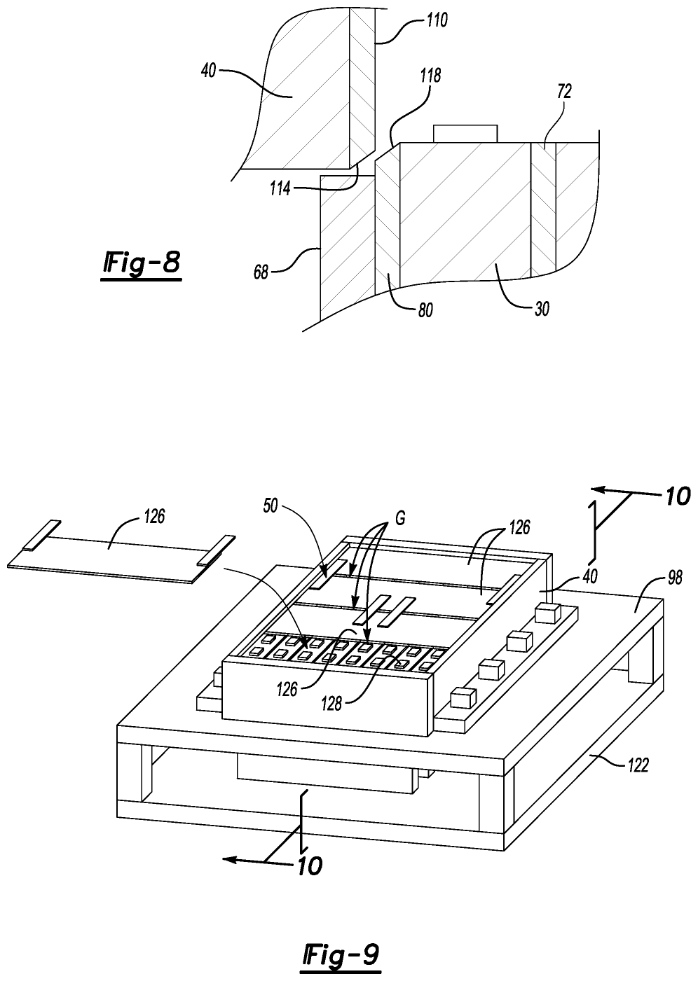

With reference to FIG. 9, after the cell matrix 50 is positioned within the halo pallet 98, the halo pallet 98 can be positioned on a weld pallet 122. Busbar modules 126 are then installed. The busbar modules 126 electrically connect together the cell stacks 46 of the cell matrix 50. The busbar modules 126 can be secured to terminals 128 of the battery cells 30 to electrically connect together the cell stacks 46. In an example, the busbar modules 126 are connected to each cell stack 46 via laser welds.

An electrical inspection is then performed to verify that the cell stacks 46 are electrically connected. The welds can be inspected as part of the electrical inspection.

If the electrical inspection reveals that the cells stacks 46 are properly electrically connected, assembly continues and the cell stacks 46 are bonded together. The bonding, in this example, can an adhesive bonding that occurs after an adhesive is injected into gaps G between the cells stacks 46. The adhesive bonding helps to bind together the cell stacks 46 of the cell matrix 50.

Notably, the electrical inspection takes place prior to bonding together the cell stacks 46. Thus, if the electrical inspection necessitates replacing one or more of the cells 30 or one or more of the cell stacks 46, the replacement can be made without needing to rupture bonds between the cells 30.

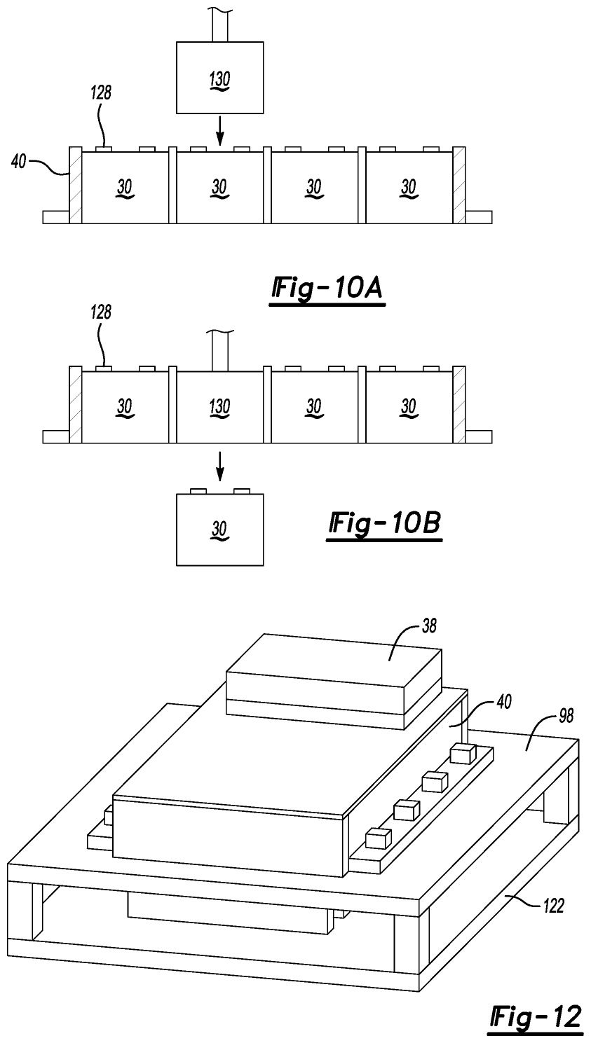

As an example, if an electrical inspection is not passed, removing and replacing one or more of the battery cells 30 in the cell matrix 50 may be required. Referring to FIGS. 10A and 10B, to remove one or more of the battery cells 30, a pusher 130 or “dummy block” can be used to extract one or more of the battery cells 30 out of the cell matrix 50 as the remaining battery cells 30 of the cell matrix 50 are held by the enclosure halo 40. The pusher 130, in this example, pushes an entire cell stack 46 from the enclosure halo 40. The pusher 130 can be moved vertically until the pusher 130 presses against one or more of the battery cells 30 out of the cell matrix 50. This removal is facilitated the battery cells 30 not being bonded to one another.

After sufficient movement, the pusher 130 eventually occupies the place of the removed one or more battery cells 30. The pusher 130 can stay in this position until one or more replacement battery cells are ready for insertion into the cell matrix 50. At which time, the pusher 130 is gradually withdrawn as the one or more replacement battery cells are inserted. The pusher 130 can be actuated by a servo or spindle-driven ball screw press, for example. The pusher 130 may alternatively be withdrawn after removal of one or more battery cells 30.

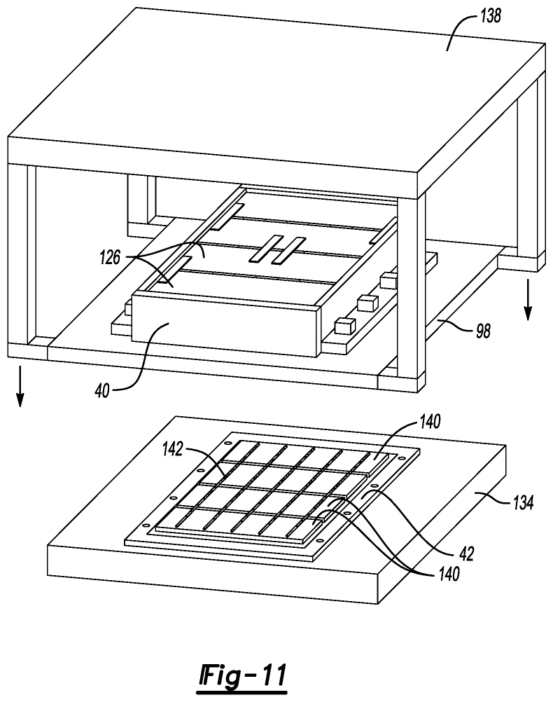

Referring now to FIG. 11, after the busbar modules 126, busbars, and other electronics modules are installed and electrical connections are made and tested, the enclosure halo 40 and the cell matrix 50 are positioned adjacent the enclosure floor 42, which is held by a tray pallet 134. A robotic lifter 138 can be used to position the halo pallet 98.

One or more thermal exchange plates 140 are positioned on the enclosure floor 42. An adhesive 142, such as an adhesive thermal interface material, is deposited on the one or more thermal exchange plates 140.

The tray pallet 134, the enclosure floor 42, and the one or more thermal exchange plates 140 with the adhesive 142 are then moved vertically relative to the halo pallet 98, enclosure halo 40, and the cell matrix 50 until the enclosure floor 42 is in a position appropriate for securement to the enclosure halo 40.

The enclosure floor 42 is then secured to the enclosure halo 40 via welds or mechanical fasteners, for example. This sandwiches the adhesive 142 between the cell matrix 50 and the enclosure floor 42. In addition to the adhesive deposited into the gaps G, the adhesive 142 cures to bond the cells stacks 46 together and to the thermal exchange plates 140.

To fully enclose the cell matrix 50 within the enclosure assembly 34, the enclosure cover 38 is then secured to the enclosure halo 40 as shown in FIG. 12.

Features of this disclosure include electrically connecting and inspecting a cell matrix prior to forming substantially permanent bonds between the cells of the cell matrix. Rupture bonds, particularly adhesive bonds, is thus not required in order to remove and replace cells.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly method, comprising:
inserting a plurality of cell stacks into an enclosure structure that compresses the plurality of cell stacks;
electrically connecting the plurality of cells stacks together; and
bonding the plurality of cell stacks after electrically connecting the plurality of cells stacks.

2. The method of claim 1, wherein electrically connecting comprises electrically connecting using busbars.

3. The method of claim 1, further compressing the plurality of cells stacks during the inserting using a compressing machine.

4. The method of claim 1, wherein the enclosure structure compresses each cell stack within the plurality of cell stacks along a respective cell stack axis.

5. The method of claim 4, wherein the inserting moves the cell stack relative to the enclosure structure in a direction that is perpendicular to the cell stack axes.

6. The method of claim 1, wherein the bonding is an adhesive bonding.

7. The method of claim 1, wherein the bonding is an adhesive thermal interface material.

8. The method of claim 1, further comprising conducting an electrical inspection after electrically connecting and prior to the bonding.

9. The method of claim 8, further comprising replacing on or more cells in one or more of the cell stacks after the electrical inspection and prior to the bonding.

10. The method of claim 1, further comprising electrically connecting the plurality of cell stacks together by securing at least one busbar to a plurality of terminals of the plurality of cell stacks.

11. The method of claim 10, wherein the enclosure structure is an enclosure halo.

12. The method of claim 11, further comprising securing an enclosure cover to the enclosure halo.

13. The method of claim 12, wherein the enclosure cover is a first enclosure cover that is secured to the enclosure halo such that the first enclosure cover is adjacent first sides of the plurality of cell stacks, wherein the plurality of terminals are on second sides of the plurality of cell stacks, the first sides opposite the second sides.

14. The method of claim 13, further comprising securing a second enclosure cover to the enclosure halo such that the second enclosure cover is adjacent the second sides of the plurality of cells stacks.

15. The method of claim 14, wherein the enclosure halo, the first enclosure cover and the second enclosure cover provide an enclosure assembly that encloses the plurality of cell stacks.

16. A battery pack assembly method, comprising:
electrically connecting a plurality of cell stacks while the plurality of cell stacks are compressed within an enclosure structure; and
adhesively bonding the plurality of cell stacks after electrically connecting together the plurality of cells.

17. The method of claim 16, wherein the enclosure structure is an enclosure halo.

18. The method of claim 16, wherein a traction battery of an electrified vehicle includes the cells stacks.

19. The method of claim 16, replacing at least one cell within the plurality of cell stacks after electrically connecting together the plurality of cell stacks and prior to adhesively bonding together the plurality of cell stacks.
